(19) United States
(12) Patent Application Publication
(10) Pub. No.: US 2026/0236516 A1
(43) Pub. Date: Aug. 13, 2026

(54) CONTENT SEARCH METHOD, ELECTRONIC DEVICE, AND COMPUTER-READABLE STORAGE MEDIUM

(71) Applicant: Beijing Zitiao Network Technology Co., Ltd., Beijing (CN)

(72) Inventor: Shengru WANG, Beijing (CN)

(21) Appl. No.: 19/160,398

(22) PCT Filed: Feb. 21, 2024
(86) PCT No.: PCT/CN2024/077904

§ 371 Date: Aug. 27, 2025

(30) Foreign Application Priority Data
Feb. 28, 2023 (CN) 202310200754.0

(51) Int. Cl. G06F 16/338; G06F 40/58

(52) U.S. Cl. CPC G06F 16/338; G06F 40/58

(57) ABSTRACT

A content search method and apparatus, an electronic device and a computer-readable storage medium are provided. The method includes: acquiring search information input by a user in response to a search operation triggered by the user; generating a search field based on the search information; searching for data information matched with the search field to obtain a search result; determining a system language corresponding to a terminal device of the user; and-displaying the search result matched with the system language in a display interface.

This application claims priority to Chinese Patent Application No. 202310200754.0, filed on Feb. 28, 2023, the disclosure of which is incorporated herein by reference in its entirety as a part of the present application.

### TECHNICAL FIELD

Embodiments of the present disclosure relate to a content search method and apparatus, a device, a computer-readable storage medium, and a product.

### BACKGROUND

With the improvement of hardware performance of terminal device and the continuous progress of artificial intelligence technology, there are more and more applications (APP) running on the terminal device. Taking the content search application as an example, the users who utilize the application may be of different nationalities and input the search field in different languages, respectively. In the scenario of multi-party cooperation, since each party uses native language to edit effect content, the effect content obtained by searching is often written by many different languages. It is rather difficult for the user to browse the effect content.

### SUMMARY

Embodiments of the present disclosure provide a content search method and apparatus, a device, a computer-readable storage medium and a product for solving the technical problem that a user cannot quickly read data information obtained by searching in a multi-language scenario.

In a first aspect, embodiments of the present disclosure provide a content search method including:
acquiring search information input by a user in response to a search operation triggered by the user;
generating a search field based on the search information;
searching for data information matched with the search field to obtain a search result;
determining a system language corresponding to a terminal device of the user; and
displaying the search result matched with the system language in a display interface.

In a second aspect, embodiments of the present disclosure provide a content search apparatus including:
an acquisition module, configured to acquire search information input by a user in response to a search operation triggered by the user;
a generation module, configured to generate a search field based on the search information;
a search module, configured to search for data information matched with the search field to obtain a search result;
a determination module, configured to determine a system language corresponding to a terminal device of the user; and
a display module, configured to display the search result matched with the system language in a display interface.

In a third aspect, embodiments of the present disclosure provide an electronic device including a processor and a memory; wherein
the memory is configured to store computer-executable instructions; and
the processor is configured to execute the computer-executable instructions stored in the memory so as to perform the content search method as described above in the first aspect and the various possible designs of the first aspect.

In a fourth aspect, embodiments of the present disclosure provide a computer-readable storage medium having computer-executable instructions stored therein, where the computer-executable instructions, when executed by a processor, are configured to implement the content search method as described above in the first aspect and the various possible designs of the first aspect.

In a fifth aspect, embodiments of the present disclosure provide a computer program product including a computer program, where the computer program, when executed by a processor, is configured to implement the content search method as described above in the first aspect and in the various possible designs of the first aspect.

### BRIEF DESCRIPTION OF DRAWINGS

In order to more clearly illustrate the technical solutions in the embodiments of the present disclosure, the drawings to be used in the description of the embodiments will be briefly introduced below. It will be apparent to those skilled in the art that the drawings in the following description are only related to some embodiments of the present disclosure, and that other drawings may be obtained from the drawings without any creative works.

FIG. 1 is a flowchart of a content search method according to an embodiment of the present disclosure;

FIG. 2 is a schematic diagram illustrating a splicing operation according to an embodiment of the present disclosure;

FIG. 3 is a flowchart of a content search method according to yet another embodiment of the present disclosure;

FIG. 4 is a schematic diagram illustrating interface interaction according to an embodiment of the present disclosure;

FIG. 5 is a structural diagram of a content search apparatus according to an embodiment of the present disclosure; and

FIG. 6 is a structural diagram of an electronic device according to an embodiment of the present disclosure.

### DETAILED DESCRIPTION

To make the objectives, technical solutions and advantages of the embodiments of the present disclosure more apparent, the technical solutions of the embodiments of the present disclosure will be described below in a clearly and fully understandable way in connection with the drawings related to the embodiments of the present disclosure. It is obvious that the described embodiments are just a part but not all of the embodiments of the present disclosure. Based on the embodiments of the present disclosure, those ordinary skilled in the art can obtain other embodiment(s), without any inventive work, which should be within the scope of protection of the present disclosure.

In order to solve the technical problem that a user cannot quickly read data information obtained by searching in a multi-language scenario, the present disclosure provides a content search method and apparatus, a device, a computer-readable storage medium and a product.

It should be noted that the content search method and apparatus, the device, the computer-readable storage medium and the product provided by the present disclosure can be applied to any multi-language content search scenario.

In the working scenario of multi-language users, different users may use different common languages to write data information. For example, the data information may be effect content, and the user may compose the effect content in different languages, such as Chinese, English, Korean and Japanese. In the effect content search process, search results in a plurality of different languages may be obtained by searching based on one search field. Therefore, it is difficult and inefficient for users to browse effect content in different languages.

In the process of solving the above-mentioned technical problem, the inventors have found through research that in order to achieve good information interaction in Sino-foreign work cooperation, improve the efficiency of content browsing and lower the difficulty of content browsing, the effect content can be searched based on the search field input by a user. After obtaining the search result, the search result may be translated according to the system language of the terminal device of the user to display the search result corresponding to the system language.

The system architecture on which the present disclosure is based includes at least a terminal device, a server, and a data server. Herein, the terminal device can be provided with a content search apparatus, and the content search apparatus can be written in languages such as C/C++, Java, Shell or Python. The terminal device may be, for example, a cell phone, a desktop computer, a tablet computer, etc. The data server may be a cloud server or a cluster of servers in which a large number of pieces of data is stored. A translation engine may be provided in the server.

Based on the system architecture described above, a user can enter a search field in a terminal device. A search result matched with the search field is searched in the data server based on the search field. According to the system language of the terminal device, a translation operation is performed on the search result by invoking a translation engine in the server so that the terminal device can display the search result matched with the system language.

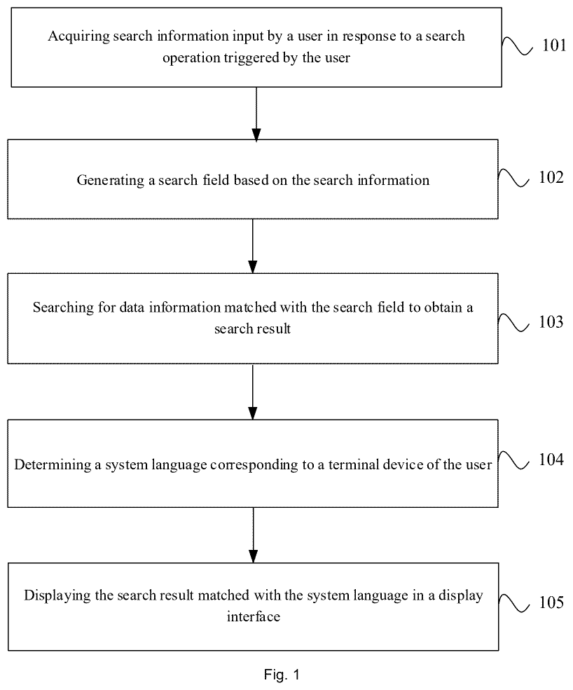

FIG. 1 is a flowchart of a content search method according to an embodiment of the present disclosure. As shown in FIG. 1, the method includes the steps as below.

Step 101, acquiring search information input by a user in response to a search operation triggered by the user.

Step 102, generating a search field based on the search information.

The execution body of this embodiment is a content search apparatus. The content search apparatus may be coupled in a terminal device to enable a content search operation to be executed based on a trigger operation of the user on the terminal device. Alternatively, the content search apparatus may be coupled to a server capable of communicative connection with the terminal device so as to be capable of controlling the terminal device to perform the content search operation based on a trigger operation of the user on the terminal device.

In this embodiment, the user may trigger a search operation within the display interface. In response to the search operation, search information input by the user may be obtained and search fields are generated based on the search information.

Optionally, a content input control may be provided in the display interface, and the user may generate search information based on the content input control and generate fields based on the search information. Thus, a content search operation can be subsequently performed according to the search field. The content input control may be an input box, or may be a content selection box, etc., and the present disclosure is not limited thereto.

Alternatively, a search control may be provided in the display interface, and the user may perform a content search operation by a trigger operation for the search control. Alternatively, the content search operation may be automatically triggered upon detecting that the user has not entered a new search field over a pre-set time threshold. Alternatively, the content search operation may be automatically triggered upon detecting that a current cursor clicks on the content input control. The present disclosure is not limited as to the manner in which the search operation is triggered.

Optionally, a word segmentation operation may be performed on the search information to obtain at least one word segmentation corresponding to the search information, and the at least one word segmentation may be determined as the search field. Alternatively, keywords in the search information may be recognized as search fields. The present disclosure is not limited thereto.

Step 103, searching for data information matched with the search field to obtain a search result.

In the present embodiment, the terminal device or the server on which the content search apparatus is installed can be communicatively connected to the data server so that information interaction with the data server can be performed. The data server may have a large amount of data information stored in advance. The data information includes, but is not limited to, effect content. In practice, the effect content can be written in different languages. For example, the data server may store Chinese effect content, English effect content, Korean effect content, etc.

Further, after acquiring the search field, the search result can be obtained by searching the data server for effect contents matched with the search field. For example, effect contents including the search field may be searched in a data server and used as a search result.

Step 104, determining a system language corresponding to a terminal device of the user.

In the present embodiment, since the effect contents may respectively include different languages, in order to lower the user's difficulty in reading the search results, the system language corresponding to the user's terminal device may be determined. The system language may be a language previously set by a user for an operating system of a terminal device. Additionally, or alternatively, the system language may be a language used by an application software installed in the terminal device, and the present disclosure is not limited thereto.

It can be understood that the system language used by the user's terminal device can be a common language of the user. Therefore, if the search result is converted into the system language, the difficulty of reading the search result can be effectively lowered, so that the user can learn more content from the search result.

Step 105, displaying the search result matched with the system language in a display interface.

In this embodiment, after determining the system language to which the terminal device corresponds, the search result may be converted to the system language and the search result matched with the system language may be displayed in the display interface.

According to the content search method provided in the present embodiment, it acquires a search field input by a user in response to a trigger operation of the user for a pre-set search control, and searches for data information matched with the search field to obtain a search result. The data information includes, but is not limited to, effect content. The search result is translated according to a system language used by a terminal device of the user, so that the search result matched with the system language can be displayed. Thus, the users with different languages as common languages can browse search results matched with their common languages. Further, the difficulty of browsing effect content is lowered and the user experience is improved.

Further, on the basis of any of the above-mentioned embodiments, the step 104 includes:
detecting whether language information corresponding to the search result is matched with the system language;
if not, performing a translation operation on the search result according to the system language to obtain a translation result; and
displaying the translation result in the display interface.

In this embodiment, if the system language corresponding to the terminal device is acquired, the search result may be converted into the system language. First, it can be detected whether the language information corresponding to the search result is matched with the system language.

Optionally, for each search result, if the search result is written in the system language, the search result may be displayed directly without performing a translation operation on the search result Conversely, for each search result, if the search result is not matched with the system language, in order to lower the difficulty of reading the search result and enable the user to learn more content from the search result, the search result can be translated according to the system language to obtain the translation result. The translation result is displayed in the display interface.

As a feasible implementation, an external translation engine may be called by a pre-set calling interface to perform a translation operation on a search result. Alternatively, translation algorithms may be built-in to enable translation of search results, which is not limited in the present disclosure.

The present embodiment provides a content search method for enabling a display language of a search result to match a system language of a terminal device by performing a translation operation on the search result when it is detected that language information corresponding to the search result is not matched with the system language, so that a user can view the search result more quickly.

Further, on the basis of any of the above-mentioned embodiments, the performing a translation operation on the search result according to the system language to obtain a translation result includes:
when the system language is a pre-set first language, detecting whether any pre-set target keyword is included in the search result; and
if so, translating fields other than the target keyword in the search result into the first language to obtain the translation result.

In this embodiment, when the system language is Chinese, the data information is required to be translated into Chinese for display. For the effect content, it may include a large number of foreign proper nouns or personal names. Direct translation of the above content into Chinese may result in inconsistent translation results and affect the user's reading experience. Therefore, in order to ensure translation accuracy, a translation operation may not be performed on the above content.

Therefore, a plurality of target keywords can be pre-set. When it is detected that the system language is a pre-set first language, it is further detected whether any pre-set target keyword is included in the search result. Herein the first language includes, but is not limited to, Chinese. If not, the search result may be directly translated. Otherwise, the fields other than the target keyword in the search result can be translated into the first language to obtain a translation result.

The content search method provided in the present embodiment can avoid the situation that the translation of the proper noun is not accurate enough, which may affect the user's browsing experience, by detecting whether any pre-set target keyword is included in the search result and performing a translation operation on fields other than the target keyword when detecting that the system language is a pre-set first language.

Further, on the basis of any of the above-mentioned embodiments, after the performing a translation operation on the search result according to the system language to obtain a translation result, it further includes:
performing a splicing operation on the translation result and the search result by a pre-set target character to obtain a splicing result.

The step 104 includes:
displaying the splicing result in the display interface, where the splicing result includes the search result matched with the system language.

In the present embodiment, after performing a translation operation on the search result to obtain a translation result, a splicing operation can be performed on the translation result and the search result by a pre-set target character to obtain a splicing result. Thus, subsequent to determining the system language of the terminal device of the user, the splicing result may be displayed on a display interface, and the splicing result includes the search result matched with the system language.

Further, on the basis of any of the above-mentioned embodiments, the performing a splicing operation on the translation result and the search result by a pre-set target character to obtain a splicing result includes:
splicing the translation result at a rear side of the search result by a pre-set first target character to obtain a splicing result.

Alternatively, splicing the translation result at a lower side of the search result by a pre-set second target character to obtain a splicing result.

In this embodiment, the target character may include a first target character and a second target character. Here, the first target character may be “//”. In practical applications, a splicing result can be obtained by splicing the translation result at the rear side of the search result by the pre-set first target character. Alternatively, the second target character may be “—” , and the translation result may be spliced at the lower side of the search result by the pre-set second target character to obtain a splicing result.

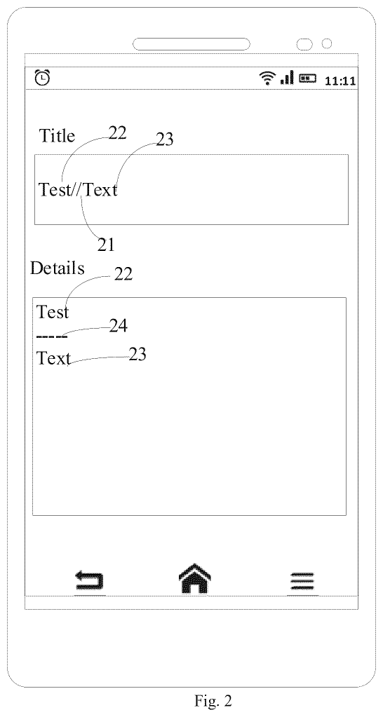

FIG. 2 is a schematic diagram illustrating a splicing operation according to an embodiment of the present disclosure. As shown in FIG. 2, a translation result 23 may be spliced at a rear side of a search result 22 by using a pre-set first target character 21. Alternatively, the translation result 23 may be spliced at a lower side of the search result 22 by using a pre-set second target character 24.

Further, on the basis of any of the above-mentioned embodiments, the method, after the performing a splicing operation on the translation result and the search result by a pre-set target character to obtain a splicing result, further includes:
in response to an editing request triggered by the user for the search result, acquiring the search result from the splicing result according to the target character in the splicing result; and performing an editing operation on the search result according to a pre-set trigger operation of the user for the search result.

In the present embodiment, after acquiring a search result and displaying the search result corresponding to the system language in the display interface, the user can perform an editing operation on the search result according to actual requirements. For example, the user may perform an editing operation on the effect contents currently searched according to actual needs.

Optionally, since the search result and the translation result are spliced in the splicing result by using a target character, the extraction of the search result or the translation result can be subsequently realized based on the target character. In response to a user-triggered editing request for the search result, the search result in the splicing result may be obtained according to the target character in the splicing result. An editing operation is performed on the search result according to a pre-set trigger operation of the user for the search result. The editing operation includes, but is not limited to, adding, deleting, modifying, etc.

Optionally, the user may also realize an editing operation on the translation result by triggering an editing request. Optionally, a translation result in the splicing result may be obtained based on the target character in the splicing result. An editing operation is performed on the translation result in response to a pre-set trigger operation of the user for the translation result.

As a feasible implementation, a pre-set selection control may also be displayed in response to a user-triggered editing request. The selection control includes a search result option and a translation result option. A target editing object selected by the user is determined in response to a selection operation by the user based on the selection control, and an editing operation is performed on the target editing object.

According to the content search method provided in the present embodiment, it obtains a splicing result by performing a splicing operation on the translation result and the search result using the pre-set target character. Thus, a search result matched with the system language can be acquired in the splicing result according to the system language for displaying subsequently, so that the language of the displayed search result is matched with the system language, which lowers the difficulty of reading the search result and improves the user experience.

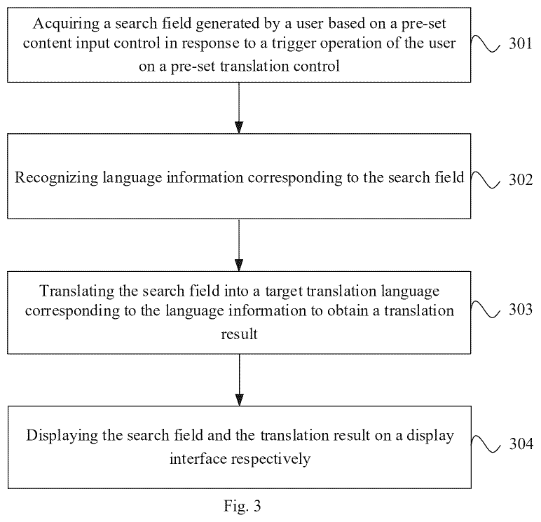

FIG. 3 is a flowchart of a content search method according to yet another embodiment of the present disclosure. On the basis of any of the above-mentioned embodiments, as shown in FIG. 3, the display interface further includes a pre-set translation control. The method further includes the steps below.

Step 301, acquiring a search field generated by the user based on a pre-set content input control in response to a trigger operation of the user for a pre-set translation control.

Step 302, recognizing language information corresponding to the search field.

Step 303, translating the search field into a target translation language corresponding to the language information to obtain a translation result.

Step 304, displaying the search field and the translation result, respectively, in a display interface.

In the present embodiment, when inputting a search field, a user can also quickly translate the search field according to actual needs.

Optionally, a pre-set translation control is also included in the display interface. In addition, a content input control may be provided in the display interface, and the user may generate a search field based on the content input control. A search field generated by the user based on the content input control is acquired in response to a trigger operation of the user for a pre-set translation control. The language information corresponding to the search field is recognized. For example, whether Chinese is included in the search field may be recognized, or the language to which the search field belongs may be recognized. The recognition of the language information may be accomplished by a regular expression. Alternatively, the recognition of the language information may be accomplished by a pre-set language recognition algorithm, which is not limited by the present disclosure. Further, after determining the language information, the search field may be translated into a target translation language corresponding to the language information to obtain a translation result. Thus, the search field and the translation result can be displayed separately in the display interface.

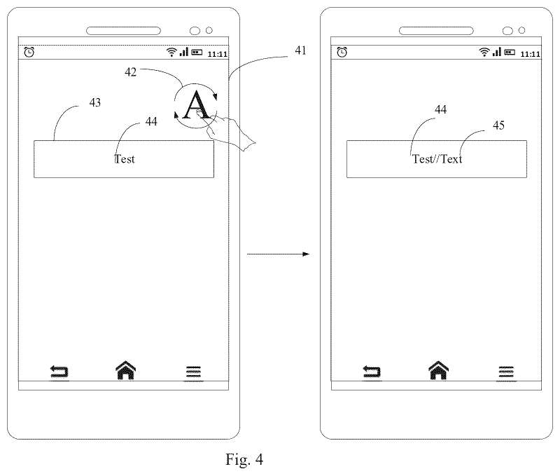

FIG. 4 is a schematic diagram illustrating interface interaction according to an embodiment of the present disclosure. As shown in FIG. 4, a display interface 41 includes a pre-set translation control 42 and a pre-set content input control 43. The user can perform a content input operation based on the pre-set content input control 43. In response to a trigger operation of the user for the translation control 42, a search field 44 in the content input control 43 may be acquired and translated to obtain a translation result 45. The search field 44 and the translation result 45 are displayed in the display interface 41.

The present embodiment provides a content search method, which can quickly implement a translation operation on a search field input by a user, by translating the search field into a target translation language corresponding to language information in response to a trigger operation of the user for a pre-set translation control.

Further, on the basis of any of the above-mentioned embodiments, the step 301 includes the steps below:
acquiring an input content generated by the user in response to a content input operation of the user which is triggered based on a pre-set content input control;
storing the input content in a pre-set storage path in response to a pre-set trigger operation of the user within a display page; and
acquiring the input content from the pre-set storage path in response to a trigger operation of the user for the per-set translation control, and determining the input content as the search field.

In this embodiment, the input content generated by the user is obtained in response to a user's content input operation triggered based on the pre-set content input control. The input content is stored to the pre-set storage path in response to the pre-set trigger operation by the user in the display page. Here, the pre-set trigger operation includes, but is not limited to, a cursor moving out of the content input control, or that there is no input content over a pre-set time threshold, or the input of the search field reaching a pre-set number threshold, etc.

Further, a translation operation may be performed on the search field by a user through a trigger operation of the user for the translation control. In response to a trigger operation of the user for the translation control, the input content is acquired from the pre-set storage path, and the input content is determined as the search field.

The present embodiment provides a content search method, which can avoid the loss of the input content generated by the user on the basis of realizing rapid translation of the search field, by storing the input content in a pre-set storage path in response to a pre-set trigger operation of the user in a display page, acquiring the input content from the pre-set storage path in response to a trigger operation of the user for a translation control, and determining the input content as the search field.

Further, on the basis of any of the above-mentioned embodiments, the translating the search field into a target translation language corresponding to the language information to obtain a translation result includes the steps below:
detecting whether a pre-set first language is included in the search field according to language information corresponding to the search field;
if it is detected that the pre-set first language is included in the search field, translating the search field into a second language corresponding to the first language; and
if it is detected that the pre-set first language is not included in the search field, translating the search field into the first language.

In this embodiment, in order to perform a translation operation on a search field, firstly, it's detected whether a pre-set first language is included in the search field according to language information corresponding to the search field. The first language may be a language pre-set by the user, for example, it may be Chinese.

Further, if it is detected that the pre-set first language is included in the search field, the search field is translated into a second language corresponding to the first language. Here, the correspondence between the first language and the second language can be pre-set by the user. If it is detected that the search field does not include the pre-set first language, the search field is translated into the first language.

For example, the first language may be Chinese and the second language may be English. If it is detected that the search field includes Chinese, the search field may be translated into an English field. If it is detected that Chinese is not included in the search field, the search field may be translated into Chinese.

As a feasible implementation, a regular matching calculation may be performed on the search field to recognize whether the search field includes the first language and to obtain the language information.

The content search method provided in the present embodiment detects whether a pre-set first language is included in the search field according to language information corresponding to the search field, and performs translation operations in different translation modes according to different detection results, so that the translation of the search field can be adapted to different application scenarios, and the accuracy of the translation of the search field can be improved.

Further, on the basis of any of the above-mentioned embodiments, the translating the search field into a target translation language corresponding to the language information to obtain a translation result includes the steps below:
acquiring a language mapping relationship table pre-set by the user, where the language mapping relationship table includes a plurality of mapping relationships between languages and translation languages; and
determining a target translation language corresponding to the language information according to the language mapping relationship table, and performing a translation operation on the search field according to the target translation language to obtain the translation result.

In this embodiment, the language mapping relationship table may also be set in advance. Here, the language mapping relationship table includes a plurality of mapping relationships between languages and translation languages. For example, the language mapping relationship table may include: if the search field includes Chinese, translating the search field into English; if the search field includes English, translating the search field into Chinese, etc.

After acquiring a search field and determining language information corresponding to the search field, in response to a translation operation triggered by the user, the pre-set language mapping relationship table can be obtained. A target translation language corresponding to the language information is determined according to the language mapping relationship table, and a translation operation is performed on the search field according to the target translation language to obtain the translation result.

The present embodiment provides a content search method, which can realize an accurate translation of the search field based on a language mapping relationship table by pre-setting the language mapping relationship table.

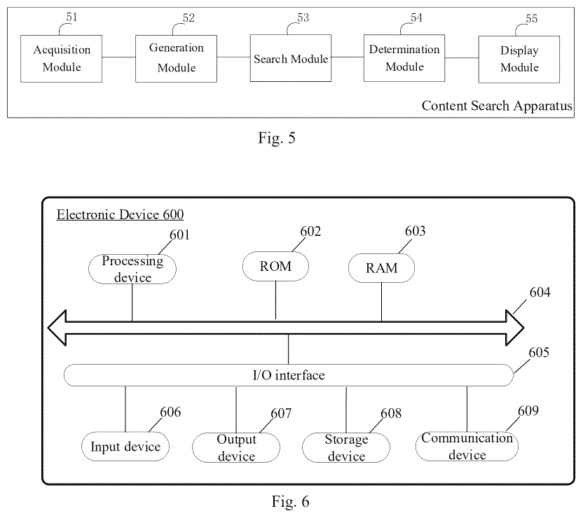

FIG. 5 is a structural diagram of a content search apparatus according to an embodiment of the present disclosure. As shown in FIG. 5, the apparatus includes an acquisition module 51, a generation module 52, a search module 53, a determination module 54 and a display module 55. Herein, the acquisition module 51 is configured to acquire search information input by a user in response to a search operation triggered by the user. The generation module 52 is configured to generate a search field based on the search information. The search module 53 is configured to search for data information matched with the search field to obtain a search result. The determination module 54 is configured to determine a system language corresponding to a terminal device of the user. The display module 55 is configured to display the search result matched with the system language in a display interface.

Further, on the basis of any of the above-mentioned embodiments, the display module is configured to detect whether language information corresponding to the search result is matched with the system language; if not, perform a translation operation on the search result according to the system language to obtain a translation result; and display the translation result in the display interface.

Further, on the basis of any of the above-mentioned embodiments, when the system language is a pre-set first language, the display module is configured to detect whether any pre-set target keyword is included in the search result; and if so, translate fields other than the target keyword in the search result into the first language to obtain the translation result.

Further, on the basis of any of the above-mentioned embodiments, the apparatus further includes a splicing module configured to perform a splicing operation on the translation result and the search result by a pre-set target character to obtain a splicing result. The display module is configured to acquire, from the splicing result, a search result matched with the system language according to the system language and display the search result.

Further, on the basis of any of the above-mentioned embodiments, the splicing module is configured to splice the translation result at a rear side of the search result by a pre-set first target character to obtain a splicing result. Alternatively, the translation result is spliced at a lower side of the search result by a pre-set second target character to obtain a splicing result.

Further, on the basis of any of the above-mentioned embodiments, the apparatus further includes an acquisition module configured to acquire a search result from the splicing result according to a target character in the splicing result, in response to an editing request triggered by the user for the search result; and an editing module configured to perform an editing operation on the search result according to a pre-set trigger operation of the user for the search result.

Further, on the basis of any of the above-mentioned embodiments, the display interface further includes a pre-set translation control. The apparatus further includes: an acquisition module configured to acquire a search field generated by the user based on a pre-set content input control in response to a trigger operation of the user for the pre-set translation control; a recognition module configured to recognize language information corresponding to the search field; a translation module configured to translate the search field into a target translation language corresponding to the language information to obtain a translation result; and a display module configured to display the search field and the translation result in the display interface, respectively.

Further, on the basis of any of the above-mentioned embodiments, the acquisition module is configured to: acquire an input content generated by the user in response to a content input operation of the user which is triggered based on a pre-set content input control; store the input content in a pre-set storage path in response to a pre-set trigger operation of the user in a display page; acquire the input content from the pre-set storage path in response to a trigger operation of the user for the translation control, and determine the input content as the search field.

Further, on the basis of any of the above-mentioned embodiments, the translation module is configured to: detect whether a pre-set first language is included in the search field according to language information corresponding to the search field, and translate the search field into a second language corresponding to the first language if it is detected that the pre-set first language is included in the search field, or translate the search field into the first language if it is detected that the pre-set first language is not included in the search field.

Further, on the basis of any of the above-mentioned embodiments, the recognition module is configured to perform a regular matching calculation on the search field to recognize whether the search field includes the first language, and to obtain the language information.

Further, on the basis of any of the above-mentioned embodiments, the translation module is configured to: acquire a language mapping relationship table pre-set by the user, where the language mapping relationship table includes a plurality of mapping relationships between languages and translation languages; determine a target translation language corresponding to the language information according to the language mapping relationship table, and perform a translation operation on the search field according to the target translation language to obtain the translation result.

The present embodiment provides an apparatus which can be used to implement the technical solution of the above-mentioned method embodiment, with similar implementation principles and technical effects. The present embodiment will not be described in detail herein.

In order to implement the above-described embodiments, the embodiments of the present disclosure also provide an electronic device including: a processor and a memory;

the memory stores computer-executed instructions; and the processor executes the computer-executed instructions stored in the memory so that the processor performs the content search method as described in any of the above embodiments.

FIG. 6 is a structural diagram of an electronic device according to an embodiment of the present disclosure. As shown in FIG. 6, the electronic device 600 may be a terminal device or a server. Here, the terminal device may include, but is not limited to, a mobile terminal such as a mobile phone, a notebook computer, a digital broadcast receiver, a Personal Digital Assistant (PDA), a Portable Android Device (PAD), a Portable Media Player (PMP), an in-vehicle terminal (e.g., an in-vehicle navigation terminal), and the like; and a fixed terminal such as a digital TV, a desktop computer, and the like. The electronic device shown in FIG. 6 is only one example and should not impose any limitation on the functionality and scope of use of embodiments of the present disclosure.

As shown in FIG. 6, the electronic device 600 may include a processing device (e.g., a central processing device, a graphics processor, etc.) 601 that may perform various suitable actions and processes in accordance with a program stored in a read-only memory (ROM) 602 or a program loaded from the storage device 608 into a random-access memory (RAM) 603. Various programs and data required for the operation of the electronic device 600 can also be stored in the RAM 603. The processing device 601, the ROM 602, and the RAM 603 are connected to each other via a bus 604. An input/output (I/O) interface 605 is also connected to the bus 604.

In general, the following devices may be connected to an I/O interface 605: an input device 606 including, for example, a touch screen, a touch pad, a keyboard, a mouse, a camera, a microphone, an accelerometer, a gyroscope, etc. ; an output device 607 including, for example, a liquid crystal display (LCD), a speaker, a vibrator, etc. ; a storage device 608 including, for example, a magnetic tape, a hard disk, etc. ; and a communication device 609. The communication device 609 may allow the electronic device 600 to have wireless or wired communication with other devices to exchange data. Although FIG. 6 shows an electronic device 600 having various devices, it should be understood that not all illustrated devices are required to be implemented or provided. More or fewer devices may alternatively be implemented or provided.

In particular, processes described above with reference to flowcharts may be implemented as computer software programs in accordance with embodiments of the present disclosure. For example, embodiments of the present disclosure include a computer program product including a computer program embodied on a computer-readable medium, the computer program including program code for performing the methods illustrated in the flowcharts. In such embodiments, the computer program may be downloaded and installed from a network via the communication device 609, or from the storage device 608, or from the ROM 602. The computer program, when executed by the processing device 601, performs the functions defined above in the method of embodiments of the present disclosure.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some case. For example, the first acquisition unit can also be described as “a unit for acquiring at least two Internet Protocol addresses”.

The functions described above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, a content search method is provided, including:
acquiring search information input by a user in response to a search operation triggered by the user;
generating a search field based on the search information;
searching for data information matched with the search field to obtain a search result;
determining a system language corresponding to a terminal device of the user; and
displaying the search result matched with the system language in a display interface.

According to one or more embodiments of the present disclosure, the displaying the search result matched with the system language in a display interface includes:
detecting whether language information corresponding to the search result is matched with the system language;
in response to detecting that the language information corresponding to the search result is not matched with the system language, performing a translation operation on the search result according to the system language to obtain a translation result; and
displaying the translation result in the display interface.

According to one or more embodiments of the present disclosure, the performing a translation operation on the search result according to the system language to obtain a translation result includes:
in response to the system language being a pre-set first language, detecting whether the search result includes a target keyword; and
in response to the search result including the target keyword, translating a field, in the search result, other than the target keyword into the first language to obtain the translation result.

According to one or more embodiments of the present disclosure, after the performing a translation operation on the search result according to the system language to obtain a translation result, the method further includes:
performing a splicing operation on the translation result and the search result by a pre-set target character to obtain a splicing result;
where the displaying the search result matched with the system language in a display interface includes:
acquiring, from the splicing result, a search result matched with the system language according to the system language, and displaying the search result.

According to one or more embodiments of the present disclosure, the performing a splicing operation on the translation result and the search result by a pre-set target character to obtain a splicing result includes:
splicing the translation result at a rear side of the search result by a pre-set first target character to obtain the splicing result; or
splicing the translation result at a lower side of the search result by a pre-set second target character to obtain the splicing result.

According to one or more embodiments of the present disclosure, after the performing a splicing operation on the translation result and the search result by a pre-set target character to obtain a splicing result, the method further includes:
in response to an editing request triggered by the user for the search result, acquiring the search result in the splicing result according to the target character in the splicing result; and
performing an editing operation on the search result according to a pre-set trigger operation of the user for the search result.

According to one or more embodiments of the present disclosure, the display interface further includes a pre-set translation control;
the method further includes:
acquiring the search field generated by the user based on a pre-set content input control in response to a trigger operation of the user for the pre-set translation control;
recognizing language information corresponding to the search field;
translating the search field into a target translation language corresponding to the language information to obtain a translation result; and
displaying the search field and the translation result, respectively, in the display interface.

According to one or more embodiments of the present disclosure, the acquiring the search field generated by the user based on a pre-set content input control in response to a trigger operation of the user for the pre-set translation control includes:
acquiring an input content generated by the user in response to a content input operation triggered by the user based on a pre-set content input control;
storing the input content in a pre-set storage path in response to a pre-set trigger operation of the user in a display page; and
acquiring the input content from the pre-set storage path in response to a trigger operation of the user for the translation control, and determining the input content as the search field.

According to one or more embodiments of the present disclosure, the translating the search field into a target translation language corresponding to the language information to obtain a translation result includes:
detecting whether a pre-set first language is included in the search field according to language information corresponding to the search field;
in response to the pre-set first language being included in the search field, translating the search field into a second language corresponding to the first language; and
in response to the pre-set first language being not included in the search field, translating the search field into the first language.

According to one or more embodiments of the present disclosure, the recognizing language information corresponding to the search field includes:
performing a regular matching calculation on the search field to recognize whether the first language is included in the search field and to obtain the language information.

According to one or more embodiments of the present disclosure, the translating the search field into a target translation language corresponding to the language information to obtain a translation result includes:
acquiring a language mapping relationship table pre-set by the user, where the language mapping relationship table includes a plurality of mapping relationships between languages and translation languages; and
determining the target translation language corresponding to the language information according to the language mapping relationship table, and performing the translation operation on the search field according to the target translation language to obtain the translation result.

In a second aspect, according to one or more embodiments of the present disclosure, a content search apparatus is provided, including:
an acquisition module, configured to acquire search information input by a user in response to a search operation triggered by the user;
a generation module, configured to generate a search field based on the search information;
a search module, configured to search for data information matched with the search field to obtain a search result;
a determination module, configured to determine a system language corresponding to a terminal device of the user; and
a display module, configured to display the search result matched with the system language in a display interface.

According to one or more embodiments of the present disclosure, the display module is configured to:
detect whether language information corresponding to the search result is matched with the system language;
in response to detecting that the language information is not matched with the system language, perform a translation operation on the search result according to the system language to obtain a translation result; and
display the translation result in the display interface.

According to one or more embodiments of the present disclosure, the display module is configured to:
in response to the system language being a pre-set first language, detect whether any pre-set target keyword is included in the search result; and
in response to a pre-set target keyword being included in the search result, translate a field in the search result other than the target keyword into the first language to obtain the translation result.

According to one or more embodiments of the present disclosure, the apparatus further includes:
a splicing module configured to perform a splicing operation on the translation result and the search result by a pre-set target character to obtain a splicing result;
the display module is configured to:
acquire, from the splicing result, a search result matched with the system language according to the system language and display the search result.

According to one or more embodiments of the present disclosure, the splicing module is configured to:
splice the translation result at a rear side of the search result by a pre-set first target character to obtain a splicing result; or
splice the translation result at a lower side of the search result by a pre-set second target character to obtain a splicing result.

According to one or more embodiments of the present disclosure, the apparatus further includes: an acquisition module configured to acquire a search result from the splicing result according to a target character in the splicing result, in response to an editing request triggered by the user for the search result; and an editing module configured to perform an editing operation on the search result according to a pre-set trigger operation of the user for the search result.

According to one or more embodiments of the present disclosure, the display interface further includes a pre-set translation control.

The apparatus further includes:
an acquisition module, configured to acquire a search field generated by the user based on a pre-set content input control in response to a trigger operation of the user for the pre-set translation control;
a recognition module, configured to recognize language information corresponding to the search field;
a translation module, configured to translate the search field into a target translation language corresponding to the language information to obtain a translation result; and
a display module, configured to display the search field and the translation result in the display interface, respectively.

According to one or more embodiments of the present disclosure, the acquisition module is configured to:
acquire an input content generated by the user in response to a content input operation of the user which is triggered based on a pre-set content input control;
store the input content in a pre-set storage path in response to a pre-set trigger operation of the user in a display page;
acquire the input content from the pre-set storage path in response to a trigger operation of the user for the translation control, and determine the input content as the search field.

According to one or more embodiments of the present disclosure, the translation module is configured to:
detect whether a pre-set first language is included in the search field according to language information corresponding to the search field, and
translate the search field into a second language corresponding to the first language in response to detecting that the pre-set first language is included in the search field, or translate the search field into the first language in response to detecting that the pre-set first language is not included in the search field.

According to one or more embodiments of the present disclosure, the recognition module is configured to:
perform a regular matching calculation on the search field to recognize whether the search field includes the first language, and to obtain the language information.

According to one or more embodiments of the present disclosure, the translation module is configured to:
acquire a language mapping relationship table pre-set by the user, where the language mapping relationship table includes a plurality of mapping relationships between languages and translation languages;
determine a target translation language corresponding to the language information according to the language mapping relationship table, and perform a translation operation on the search field according to the target translation language to obtain the translation result.

In a third aspect, according to one or more embodiments of the present disclosure, an electronic device is provided, including at least one processor and memory;
the memory stores computer-executable instructions; and
the at least one processor executes the computer-executable instructions so that the at least one processor performs the content search method as described above in the first aspect and the various possible designs of the first aspect.

In a fourth aspect, according to one or more embodiments of the present disclosure, a computer-readable storage medium is provided, where the computer-readable storage medium stores computer-executable instructions which, when executed by a processor, implements the content search method as described above in the first aspect and in the various possible designs of the first aspect.

In a fifth aspect, according to one or more embodiments of the present disclosure, a computer program product is provided, including a computer program which, when executed by a processor, implements the content search method as described above in the first aspect and in the various possible designs of the first aspect.

The above description merely refers to preferred embodiments of the present disclosure and the explanation of the applied technical principles. It should be understood by those skilled in the art that the disclosed scope involved in the present disclosure is not limited to the technical solutions formed by the specific combination of the above technical features, but also covers other technical solutions formed by any combination of the above technical features or their equivalent features without departing from the above disclosed concepts. For example, technical solutions formed by replacing above features with (but not limited to) technical features having similar functions disclosed in the present disclosure.

Although various operations are depicted in a specific order, it should not be construed as requiring these operations to be performed in the specific order as shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A content search method, comprising:
acquiring search information input by a user in response to a search operation triggered by the user;
generating a search field based on the search information;
searching for data information matched with the search field to obtain a search result;
determining a system language corresponding to a terminal device of the user; and
displaying the search result matched with the system language in a display interface.

2. The method according to claim 1, wherein the displaying the search result matched with the system language in a display interface comprises:
detecting whether language information corresponding to the search result is matched with the system language;
in response to detecting that the language information corresponding to the search result is not matched with the system language, performing a translation operation on the search result according to the system language to obtain a translation result; and
displaying the translation result in the display interface.

3. The method according to claim 2, wherein the performing a translation operation on the search result according to the system language to obtain a translation result comprises:
in response to the system language being a pre-set first language, detecting whether the search result comprises a target keyword; and
in response to the search result comprising the target keyword, translating a field, in the search result, other than the target keyword into the first language to obtain the translation result.

4. The method according to claim 2, wherein after the performing a translation operation on the search result according to the system language to obtain a translation result, the method further comprises:
performing a splicing operation on the translation result and the search result by a pre-set target character to obtain a splicing result;
wherein the displaying the search result matched with the system language in a display interface comprises:
displaying the splicing result in the display interface, wherein the splicing result comprises the search result matched with the system language.

5. The method according to claim 4, wherein the performing a splicing operation on the translation result and the search result by a pre-set target character to obtain a splicing result comprises:
splicing the translation result at a rear side of the search result by a pre-set first target character to obtain the splicing result; or
splicing the translation result at a lower side of the search result by a pre-set second target character to obtain the splicing result.

6. The method according to claim 4, wherein after the performing a splicing operation on the translation result and the search result by a pre-set target character to obtain a splicing result, the method further comprises:
in response to an editing request triggered by the user for the search result, acquiring the search result in the splicing result according to the target character in the splicing result; and
performing an editing operation on the search result according to a pre-set trigger operation of the user for the search result.

7. The method according to claim 1, further comprising: acquiring the search field generated by the user based on a pre-set content input control in response to a trigger operation of the user for a pre-set translation control;
wherein the acquiring the search field generated by the user based on a pre-set content input control in response to a trigger operation of the user for a pre-set translation control comprises:
acquiring an input content generated by the user in response to a content input operation triggered by the user;
storing the input content in a pre-set storage path in response to a pre-set trigger operation of the user in a display page; and
acquiring the input content from the pre-set storage path in response to the trigger operation of the user for the translation control, and determining the input content as the search field.

8. (canceled)

9. An electronic device, comprising at least one processor and a memory, wherein
the memory is configured to store computer-executable instructions; and
the at least one processor is configured to execute the computer-executable instructions stored in the memory so as to perform a content search method, comprising:
acquiring search information input by a user in response to a search operation triggered by the user;
generating a search field based on the search information;
searching for data information matched with the search field to obtain a search result;
determining a system language corresponding to a terminal device of the user; and
displaying the search result matched with the system language in a display interface.

10. A computer-readable storage medium having computer-executable instructions stored therein, wherein the computer-executable instructions, when executed by at least one processor, are configured to implement a content search method, comprising:
acquiring search information input by a user in response to a search operation triggered by the user;
generating a search field based on the search information;
searching for data information matched with the search field to obtain a search result;
determining a system language corresponding to a terminal device of the user; and
displaying the search result matched with the system language in a display interface

11. (canceled)

12. The electronic device according to claim 9, wherein in the content search method, the displaying the search result matched with the system language in a display interface comprises:
detecting whether language information corresponding to the search result is matched with the system language;
in response to detecting that the language information corresponding to the search result is not matched with the system language, performing a translation operation on the search result according to the system language to obtain a translation result; and
displaying the translation result in the display interface.

13. The electronic device according to claim 12, wherein in the content search method, the performing a translation operation on the search result according to the system language to obtain a translation result comprises:
in response to the system language being a pre-set first language, detecting whether the search result comprises a target keyword; and
in response to the search result comprising the target keyword, translating a field, in the search result, other than the target keyword into the first language to obtain the translation result.

14. The electronic device according to claim 12, wherein the content search method, after the performing a translation operation on the search result according to the system language to obtain a translation result, further comprises:
performing a splicing operation on the translation result and the search result by a pre-set target character to obtain a splicing result;
wherein the displaying the search result matched with the system language in a display interface comprises:
displaying the splicing result in the display interface, wherein the splicing result comprises the search result matched with the system language.

15. The electronic device according to claim 14, wherein in the content search method, the performing a splicing operation on the translation result and the search result by a pre-set target character to obtain a splicing result comprises:
splicing the translation result at a rear side of the search result by a pre-set first target character to obtain the splicing result; or
splicing the translation result at a lower side of the search result by a pre-set second target character to obtain the splicing result.

16. The electronic device according to claim 14, wherein the content search method, after the performing a splicing operation on the translation result and the search result by a pre-set target character to obtain a splicing result, further comprises:
in response to an editing request triggered by the user for the search result, acquiring the search result in the splicing result according to the target character in the splicing result; and
performing an editing operation on the search result according to a pre-set trigger operation of the user for the search result.

17. The electronic device according to claim 9, wherein the content search method further comprises: acquiring the search field generated by the user based on a pre-set content input control in response to a trigger operation of the user for a pre-set translation control;
wherein the acquiring the search field generated by the user based on a pre-set content input control in response to a trigger operation of the user for a pre-set translation control comprises:
acquiring an input content generated by the user in response to a content input operation triggered by the user;
storing the input content in a pre-set storage path in response to a pre-set trigger operation of the user in a display page; and
acquiring the input content from the pre-set storage path in response to the trigger operation of the user for the translation control, and determining the input content as the search field.

18. The storage medium according to claim 10, wherein in the content search method, the displaying the search result matched with the system language in a display interface comprises:
detecting whether language information corresponding to the search result is matched with the system language;
in response to detecting that the language information corresponding to the search result is not matched with the system language, performing a translation operation on the search result according to the system language to obtain a translation result; and
displaying the translation result in the display interface.

19. The storage medium according to claim 18, wherein in the content search method, the performing a translation operation on the search result according to the system language to obtain a translation result comprises:
in response to the system language being a pre-set first language, detecting whether the search result comprises a target keyword; and
in response to the search result comprising the target keyword, translating a field, in the search result, other than the target keyword into the first language to obtain the translation result.

20. The storage medium according to claim 18, wherein the content search method, after the performing a translation operation on the search result according to the system language to obtain a translation result, further comprises:
performing a splicing operation on the translation result and the search result by a pre-set target character to obtain a splicing result;
wherein the displaying the search result matched with the system language in a display interface comprises:
displaying the splicing result in the display interface, wherein the splicing result comprises the search result matched with the system language.

21. The storage medium according to claim 20, wherein in the content search method, the performing a splicing operation on the translation result and the search result by a pre-set target character to obtain a splicing result comprises:
splicing the translation result at a rear side of the search result by a pre-set first target character to obtain the splicing result; or
splicing the translation result at a lower side of the search result by a pre-set second target character to obtain the splicing result.

22. The storage medium according to claim 20, wherein the content search method, after the performing a splicing operation on the translation result and the search result by a pre-set target character to obtain a splicing result, further comprises:
in response to an editing request triggered by the user for the search result, acquiring the search result in the splicing result according to the target character in the splicing result; and
performing an editing operation on the search result according to a pre-set trigger operation of the user for the search result.
